(19) United States
(12) Patent Application Publication
(10) Pub. No.: US 2016/0069763 A1
(43) Pub. Date: Mar. 10, 2016

(54) SEMICONDUCTOR SENSOR DEVICE FORMED WITH GEL SHEET

(71) Applicant: Wai Yew Lo, Petaling Jaya (MY)

(72) Inventor: Wai Yew Lo, Petaling Jaya (MY)

(73) Assignee: Freescale Semiconductor, Inc., Austin, TX (US)

(21) Appl. No.: 14/477,881

(22) Filed: Sep. 5, 2014

(51) Int. Cl. G01L 9/00

(52) U.S. Cl. CPC G01L 9/0042

(57) ABSTRACT

A method for assembling a pressure sensor device uses a pressure-sensitive gel material that is applied to an active region of a pressure-sensing integrated circuit (IC) die. A molding compound is dispensed over the pressure-sensitive gel material to encapsulate the gel material. A portion of the molding compound is then removed to expose the gel material to an ambient environment outside of the packaged semiconductor device.

### BACKGROUND

The present invention relates generally to semiconductor sensor devices and, more particularly, to a semiconductor pressure sensor formed with a gel sheet.

Semiconductor sensor devices, such as pressure sensors, are well known. Such devices use semiconductor pressure-sensing dies to sense the ambient atmospheric pressure. These dies are susceptible to mechanical damage during packaging and environmental damage when in use, and thus they must be carefully packaged. Further, pressure-sensing dies, such as piezo resistive transducers (PRTs) and parameterized layout cells (P-cells), do not allow full encapsulation because that would impede their functionality.

FIG. 1 shows a cross-sectional side view of a conventional packaged semiconductor sensor device 100. The sensor device 100 has a pre-molded lead frame 102 that includes a metal die paddle 104 (also known as a lead frame flag), metal lead fingers 106, and molding compound 108. The molding compound 108 (i) fills areas between adjacent lead fingers 106 and between the lead fingers 106 and the die paddle 104, and (ii) forms a cavity 110 over the die paddle 104.

A P-cell 112 and a micro-control unit die (MCU) 114 are mounted on the die paddle 104 using a die-attach adhesive 116. The P-cell 112 and MCU 114 are electrically connected to one another and to the lead fingers 106 with bond wires 118. Further, the P-cell 112 and MCU 114 are encapsulated in a pressure-sensitive gel material 120, which enables the pressure of the ambient atmosphere to reach the pressure-sensing active region on the top side of the P-cell 112, while protecting the dies 112 and 114 and the bond wires 118 from mechanical damage during packaging and environmental damage (e.g., contamination and/or corrosion) when in use. The lead frame cavity 110 is covered by a lid 122, which has a vent hole 124 that exposes the gel-covered P-cell 112 to ambient atmospheric pressure outside the sensor device 100.

One problem with the sensor device 100 is the high manufacturing cost due to the use of a pre-molded lead frame 102 and the metal lid 122. The high costs result from, for example, the additional processing and inspection steps needed to form the cavity 110 in the pre-molded lead frame 102. Another problem with the sensor device 100 is the potential for defects that may result from forming the cavity 110. Yet another problem is the cost associated with the relatively large volume of pressure-sensitive gel material 120 needed to fill the cavity 110. Accordingly, it would be advantageous to have a less costly method of assembling a pressure sensor device.

### BRIEF DESCRIPTION OF THE DRAWINGS

Embodiments of the present invention are illustrated by way of example and are not limited by the accompanying figures, in which like references indicate similar elements. Elements in the figures are illustrated for simplicity and clarity and have not necessarily been drawn to scale. For example, the thicknesses of layers and regions may be exaggerated for clarity.

FIG. 1 shows a cross-sectional side view of a conventional packaged semiconductor sensor device;

FIG. 2 shows a cross-sectional side view of a packaged semiconductor sensor device according to one embodiment of the present invention;

FIGS. 3A-3I show cross-sectional side views that illustrate steps of an exemplary method of assembling multiple instances of the sensor device of FIG. 2;

FIG. 4 shows a cross-sectional side view of a packaged semiconductor sensor device according to another embodiment of the present invention; and

FIGS. 5A-5F show cross-sectional side views that illustrate steps of an exemplary method of assembling multiple instances of the sensor device of FIG. 4.

### DETAILED DESCRIPTION

Detailed illustrative embodiments of the present invention are disclosed herein. However, specific structural and functional details disclosed herein are merely representative for purposes of describing example embodiments of the present invention. Embodiments of the present invention may be embodied in many alternative forms and should not be construed as limited to only the embodiments set forth herein. Further, the terminology used herein is for the purpose of describing particular embodiments only and is not intended to be limiting of example embodiments of the present invention.

As used herein, the singular forms “a,” “an,” and “the,” are intended to include the plural forms as well, unless the context clearly indicates otherwise. It further will be understood that the terms “comprises,” “comprising,” “has,” “having,” “includes,” and/or “including” specify the presence of stated features, steps, or components, but do not preclude the presence or addition of one or more other features, steps, or components. It also should be noted that, in some alternative implementations, the functions/acts noted may occur out of the order noted in the figures. For example, two figures shown in succession may in fact be executed substantially concurrently or may sometimes be executed in the reverse order, depending upon the functionality/acts involved.

In the following description, it will be understood that certain embodiments of the present invention are related to applying, encapsulating, and exposing pressure-sensitive gel material in packaged semiconductor sensor devices. For ease of discussion, the assembly of two exemplary packaged semiconductor sensor devices having specific lead frame configurations is described below. However, it will be understood that embodiments of the present invention are not limited to the particular lead frame configurations described below. The methods of applying, encapsulating, and exposing pressure-sensitive gel material as described below may be applied to other package configurations, including those that use substrates (e.g., land grid array or ball grid array) in lieu of, or in addition to, lead frames.

One embodiment of the present invention is a method for assembling a packaged semiconductor device. In the method, a pressure-sensitive gel material is applied to an active region of a pressure-sensing integrated circuit (IC) die. A molding compound is disposed onto all exposed surfaces of the pressure-sensitive gel material to encapsulate the pressure-sensitive gel material. A portion of the molding compound is then removed to expose the pressure-sensitive gel material to an ambient environment outside of the packaged semiconductor device.

Another embodiment of the present invention is a packaged semiconductor device comprising (i) a pressure-sensing IC die, (ii) a pressure-sensitive gel material disposed on an active region of the pressure-sensing IC die, and (iii) molding compound encapsulating the pressure-sensitive gel material. A first surface of the pressure-sensitive gel material is exposed to an ambient environment outside of the packaged semiconductor device, and a second surface of the pressure-sensitive gel material contacts the pressure-sensing IC die. Every other surface of the pressure-sensitive gel material is in contact with the molding compound.

Yet another embodiment of the present invention is a packaged semiconductor device comprising (i) a pressure-sensing IC die, (ii) a pressure-sensitive gel film mounted on an active region of the pressure-sensing IC die and extending from the pressure-sensing IC die to a side perimeter of the packaged semiconductor device, and (iii) molding compound encapsulating the pressure-sensitive gel film. An opening in the molding compound on the side perimeter of the packaged semiconductor device exposes the pressure-sensitive gel film to an ambient environment outside of the packaged semiconductor device.

FIG. 2 shows a cross-sectional side view of a packaged semiconductor sensor device 200 according to one embodiment of the present invention. Device 200 has a metal lead frame 202 that comprises a metal die paddle 204 and a plurality of metal leads 206 (only one of which is shown). In this embodiment, the metal leads 206 are situated on the left-hand side of the device 200 as it is oriented in FIG. 2, and may be situated on one or both of the fore (not shown) and aft (not shown) sides of the device 200. Note, however, that the metal leads 206 are not situated on the right-hand side of the device 200.

The sensor device 200 comprises a pressure sensor die (e.g., P-cell) 212 and a micro-control unit die (MCU) 214 mounted on (e.g., physically attached to) the metal die paddle 204 using a die-attach adhesive 216. The sensor device 200 may also comprise an acceleration-sensing die (aka G-cell) (not shown) mounted on, for example, the metal die paddle 204 in front of, or behind, dies 212 and 214. The P-cell 212 is designed to sense ambient atmospheric pressure, while the G-cell (if implemented) is designed to sense gravity or acceleration in one, two, or all three axes, depending on the particular implementation.

The MCU 214 controls, for example, the operations of, and the processing of, signals generated by the P-cell 212 and the G-cell. Note that, in some embodiments, the MCU 214 may implement both the functionality of an MCU and that of one or more other sensors, such as an acceleration-sensing G-cell, in which latter case the G-cell may be omitted. The P-cell 212, the MCU 214, and the G-cell are well-known components of semiconductor sensor devices and thus detailed descriptions thereof are not necessary for a complete understanding of the present invention.

The P-cell 212, the MCU 214, and the G-cell (if implemented) are electrically connected to one another and to the metal leads 206 via a plurality of bond wires 218. The bond wires 218 are formed from a conductive material such as aluminium, gold, or copper, and may be either coated or uncoated.

A pressure-sensitive gel material 220 is adhered onto the upper surface of the P-cell 212 using an adhesive 222. In this embodiment, the pressure-sensitive gel material 220 is a film having a fixed, rectilinear shape. The pressure-sensitive gel material 220, when initially adhered to the P-cell 212, is partially cured such that the film 220 exhibits properties that are more similar to a solid than a liquid. In other words, the film 220 holds its fixed, rectilinear shape and does not flow to conform to the shape of its surroundings. The film 220 is adhered to the upper surface of the P-cell 212 such that the film 220 extends to the right-side perimeter of the device 200.

The exposed portions of the P-cell 212, the MCU 214, and the G-cell (if implemented), their associated bond wires 218, and the exposed portions of the lead frame 202 (except the bottom) are encapsulated with a suitable molding compound 208. The molding compound 208 may be a plastic, an epoxy, a silica-filled resin, a ceramic, a halide-free material, the like, or combinations thereof, as is known in the art.

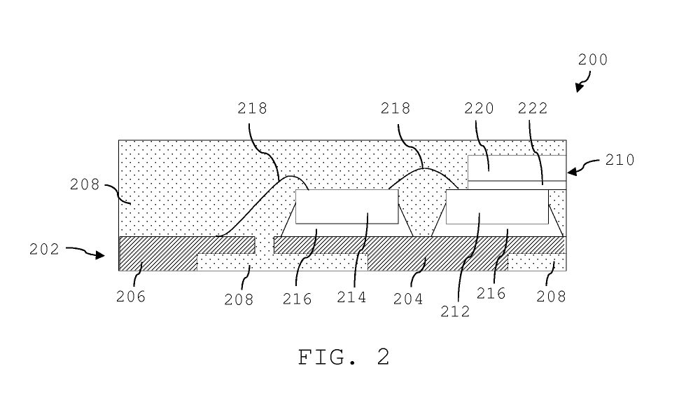

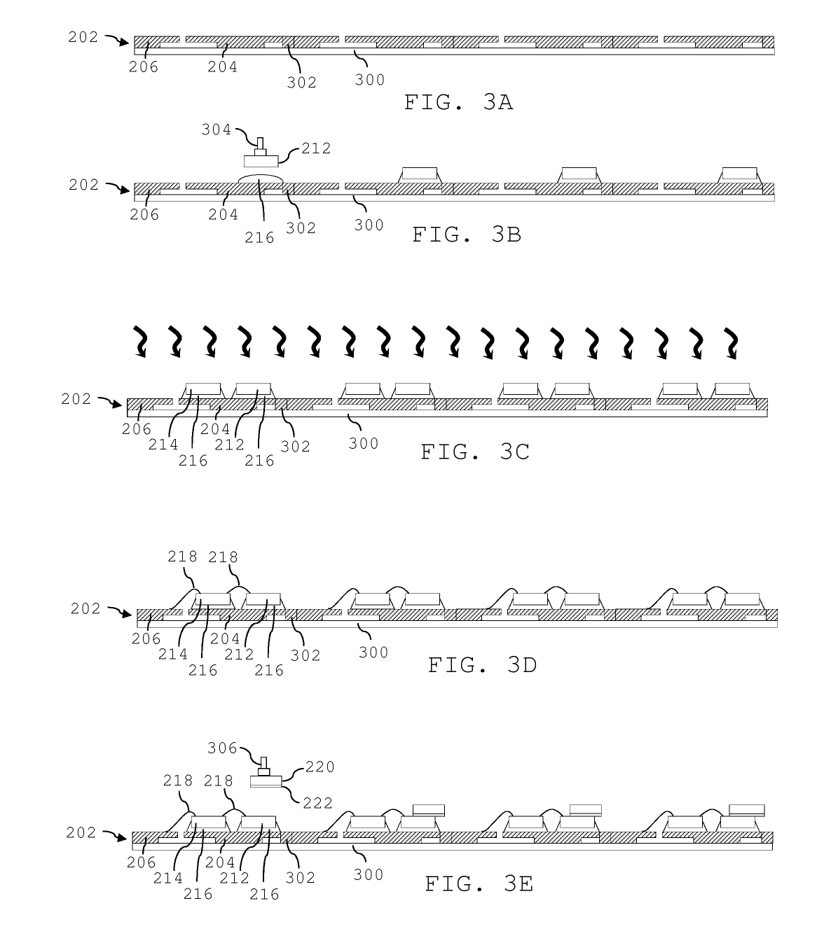

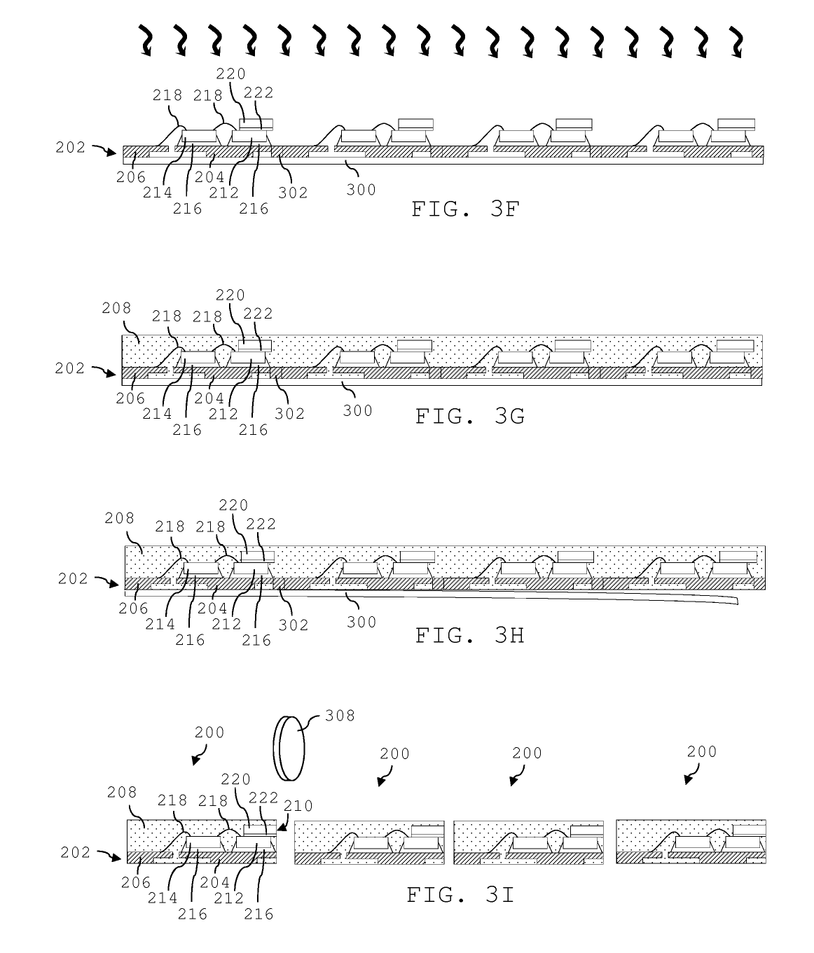

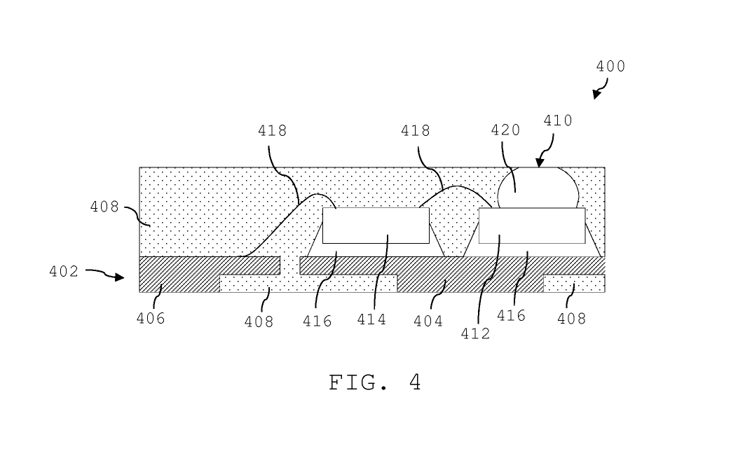

In addition, the molding compound 208 encapsulates the pressure-sensitive film 220, with the exception of (i) the bottom portion of the film 220 that abuts the P-cell 212 via adhesive 222 and (ii) the right side of the film 220, which is exposed to the ambient atmosphere via an opening 210 in the molding compound 208. The pressure-sensitive film 220 enables the pressure of the ambient atmosphere to reach the active region (not explicitly indicated in FIG. 2) on the upper surface of the P-cell 212, while protecting the P-cell 212 from (i) mechanical damage during packaging and (ii) environmental damage (e.g., contamination and/or corrosion) when in use. To understand the assembly of device 200, consider FIGS. 3A-3I.

FIGS. 3A-3I show cross-sectional side views that illustrate steps of an exemplary method of assembling multiple instances of the sensor device 200 of FIG. 2.

FIG. 3A illustrates the step of performing lead frame taping, wherein tape 300 is applied to one side of a one- or two-dimensional array of the lead frames 202 that are interconnected by metal connecting material 302.

FIG. 3B illustrates the step of conventional pick-and-place machinery 304 mounting multiple instances of the P-cell 212 onto the array of lead frames 202 using die-attach adhesive 216. The die-attach adhesive 216 may be, for example, a liquid or gel adhesive applied by the nozzle of a dispensing machine, or a tape. Although not shown, multiple instances of the MCU 214 are mounted in a similar manner.

FIG. 3C illustrates the step of curing the adhesive 216 used to mount the dies 212 and 214.

FIG. 3D illustrates the step of stringing bond wires 218 between the components of each device 200 to electrically interconnect the P-cell 212, the MCU 214, and the G-cell (if implemented) for the device to one another and to the corresponding metal leads 206.

FIG. 3E illustrates the step of mounting the pressure-sensitive gel film 220 onto the upper surface of each P-cell 212. In some embodiments of the present invention, the film 220 may be mounted using an adhesive 222 that is separate from the film 220.

In other embodiments of the present invention, the film 220 may comprise the adhesive 222. As an example, the film 220 may be silicone film part number TC-15CG-5HSV made by Shin-Etsu Chemical Co., Ltd., which comprises a high-hardness silicone layer, a soft-pad silicone layer, and a liner film. The soft-pad silicone layer is tacky, and therefore, may act as the adhesive 222. When applying the Shin-Etsu film, a sheet of the film is cut to the desired size using, for example, a saw. During the sawing, the film 220 may be cooled with a liquid (e.g., water) shower and/or spray, which may be selected to prevent the layers from separating from the liner film. Once cut to size, the liner film is removed to expose the soft-pad silicone layer, which is tacky. The tacky soft-pad silicone layer is then placed onto the upper surface of the P-cell 212 using, for example, pick-and-place machinery 306, to adhere the film 220 to the P-cell 212.

FIG. 3F illustrates the step of curing the pressure-sensitive film 220. Curing may be performed, for example, in an oven or die bonder.

FIG. 3G illustrates the step of applying the molding compound 208 to the devices 200. As shown, the pressure-sensitive film 220 in each device 200 is completely encapsulated, such that no portion of the pressure-sensitive film 220 is exposed to the ambient environment outside the device 200.

FIG. 3H illustrates the step of removing the tape 300 from the array of lead frames 202.

FIG. 3I illustrates the step of the individual semiconductor sensor devices 200 being separated from each other by a singulation process. Singulation processes are well known and may include cutting the array of devices 200 with a saw blade 308 or a laser (not shown). The saw blade 308 or laser cuts through the molding compound 208 and the metal connecting material 302 that connects adjacent devices 200.

When the devices 200 are separated, the pressure-sensitive film 220 in each device 200 is exposed via an opening 210 on the right side of the device 200 to the ambient atmosphere around the device 200. Note that the saw blade 308 or laser might cut through the pressure-sensitive film 220, the molding compound 208, or both to expose the pressure-sensitive film 220 depending on how far the pressure-sensitive film 220 extends from the P-cell.

FIG. 4 shows a cross-sectional side view of a packaged semiconductor sensor device 400 according to another embodiment of the present invention. The sensor device 400 comprises features 402-408, and 412-418, which are similar to the analogous components in FIG. 2. However, rather than covering the active region of the P-cell 412 with a pressure-sensitive gel material such as film 220 in FIG. 2, the active region of the P-cell 412 is covered with a pressure-sensitive gel 420 that is dispensed in uncured form onto the P-cell 412 using, for example, the nozzle of a conventional dispensing machine (not shown).

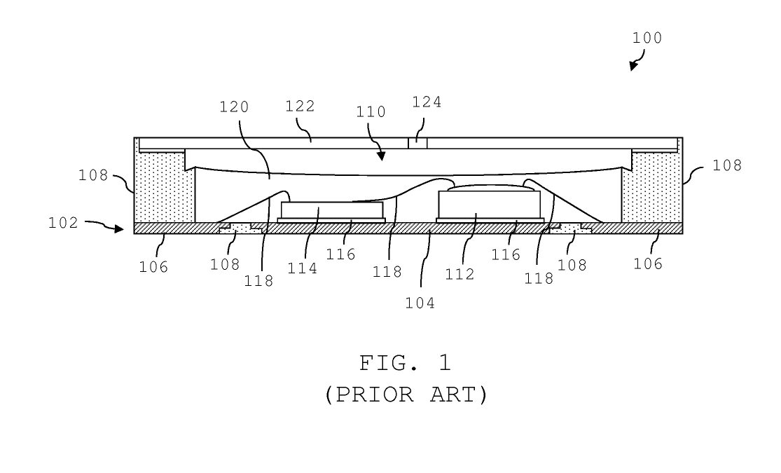

In the uncured form, the pressure-sensitive gel 420 exhibits properties that are more similar to a liquid than a solid. Thus, the pressure-sensitive gel 420 is capable of flowing to conform to the shape of its surroundings when being dispensed (just as the gel 120 conforms to the shape of the cavity 110 in FIG. 1). Further, when a drop of the pressure-sensitive gel 420 is dispensed, the drop maintains the shape of a spherical cap (i.e., a sphere that is cut off by a plane, which, in this case, is the upper surface of the P-cell 412) due to surface tension. Examples of suitable pressure-sensitive gel 420 are available from Dow Corning Corporation of Midland, Mich.

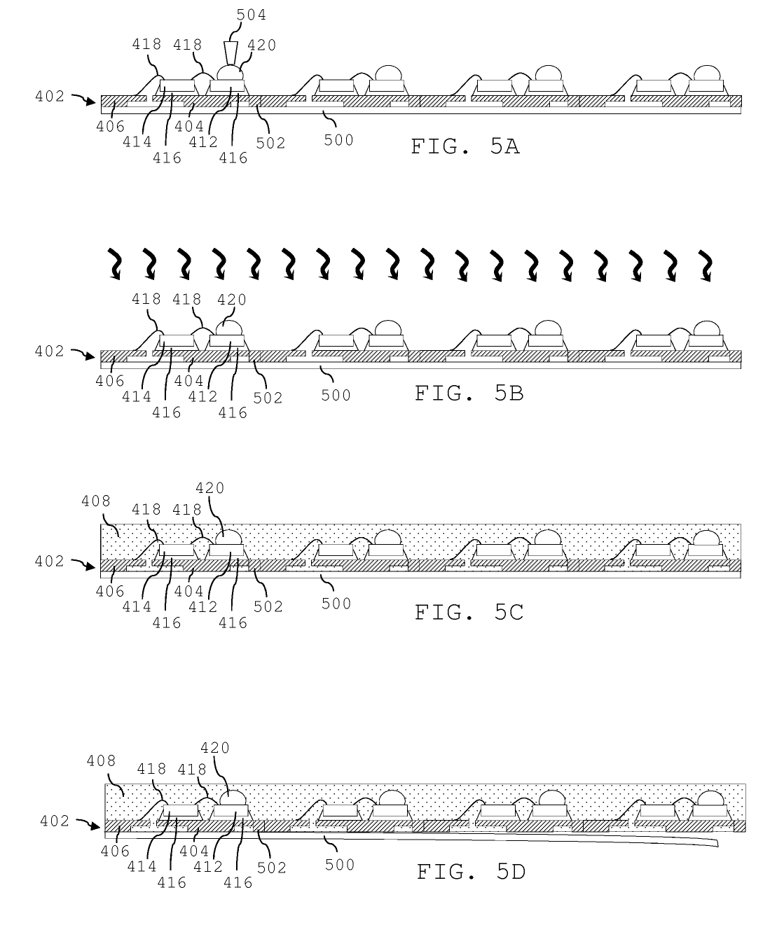

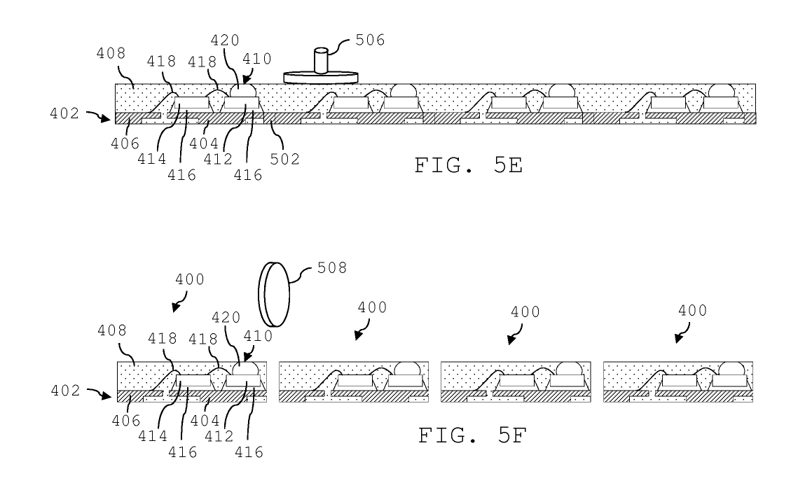

The molding compound 408 encapsulates the exposed portions of the P-cell 412, MCU 414, and a G-cell (not shown) (if implemented), their associated bond wires 418, and the exposed portions of the lead frame 402 (except the bottom). The molding compound 408 also encapsulates the exposed portions of the pressure-sensitive gel 420, with the exception of (i) the bottom of the gel that abuts the P-cell 412 and (ii) the top of the gel 420, where the gel is exposed to the ambient atmosphere via an opening 410 in the upper perimeter of the molding compound 408. The pressure-sensitive gel 420 enables the pressure of the ambient atmosphere to reach the active region on the upper surface of the P-cell 412, while protecting the P-cell 412 from mechanical and environmental damage. To understand the assembly of device 400, consider FIGS. 5A-5F.

FIGS. 5A-5F show cross-sectional side views that illustrate steps of an exemplary method of assembling multiple instances of the sensor device 400 of FIG. 4. Although not shown, prior to the step of FIG. 5A, lead frame taping, die mounting, die curing, and wire bonding may be performed in a manner similar to that shown in FIGS. 4A-4D and described above.

FIG. 5A illustrates the step of dispensing the pressure-sensitive gel material 420 onto the P-cells 412. As described above, the gel material 420 is dispensed in uncured, liquid form using, for example, a nozzle 504 of a conventional dispensing machine (not shown). Each instance of the pressure-sensitive gel material 420 has the spherical cap shape discussed above.

FIG. 5B illustrates the step of curing the pressure-sensitive gel 420. Curing may be performed, for example, in an oven or die bonder.

FIG. 5C illustrates the step of applying the molding compound 408 to the devices 400. As shown, the pressure-sensitive gel 420 in each device 400 is completely encapsulated, such that no portion of the pressure-sensitive gel 420 is exposed to the ambient environment around outside the device 400.

FIG. 5D illustrates the step of removing the tape 500 from the lead frames 402.

FIG. 5E illustrates the step of grinding the upper perimeter surface of the molding compound 408 to form an opening 410 in each device 400 that exposes the pressure-sensitive gel 420 to the ambient atmosphere around the device 400. Grinding may be performed using, for example, a grinding wheel 506. Grinding changes the shape of the pressure-sensitive gel 420 from a spherical cap to a spherical segment (i.e., a sphere that is cut off by two planes).

FIG. 5F illustrates the step of the individual semiconductor sensor devices 400 being separated from each other by a singulation process. The saw blade 508 or laser (not shown) cuts through the molding compound 408 and the metal connecting material 502 that connects adjacent devices 400.

The sensor devices 200 and 400 can be manufactured with less cost than comparable prior-art sensor devices, like those based on the conventional design of the sensor device 100 of FIG. 1, because the sensor devices 200 and 400 can be manufactured with fewer steps and smaller volumes of pressure-sensitive gel.

By encapsulating the bond wires in molding compound, the bond wires in devices 200 and 400 are less susceptible to movement than the bond wires in device 100 of FIG. 1.

Embodiments of the present invention are not limited to the particular lead frame configuration shown in FIGS. 2 and 4. According to alternative embodiments, devices of the present invention may be assembled using other lead frame configurations, including those having leads on the right-hand side of the die paddle, and package technologies that do not use lead frames (e.g., land-grid arrays and ball-grid arrays). In such embodiments that employ pressure-sensitive gel film, the film could be exposed by, for example, drilling a hole in the upper perimeter of the molding compound.

In some embodiments of the present invention, two or more integrated circuit (IC) dies may be arranged in a stacked relation. For example, a G-cell could be stacked onto an MCU.

According to alternative embodiments of the present invention, the pressure-sensitive gel may be exposed to the ambient environment around the device using a cutting instrument other than a saw blade, laser, or grinding wheel. For example, the pressure-sensitive gel may be exposed using a drill.

A lead frame is a collection of metal leads and possibly other elements (e.g., die paddles, power bars) that is used in semiconductor packaging for assembling a single packaged semiconductor device. Prior to assembly into a packaged device, a lead frame may have support structures (e.g., a rectangular metal frame) that keep those elements in place. During the assembly process, the support structures may be removed. As used herein, the term “lead frame” may be used to refer to the collection of elements before assembly or after assembly, regardless of the presence or absence of those support structures.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Terms of orientation such as “lower,” “upper,” “horizontal,” “vertical,” “above,” “below,” “up,” “down,” “top,” “bottom,” “right,” and “left” well as derivatives thereof (e.g., “horizontally,” “vertically,” etc.) should be construed to refer to the orientation as shown in the drawing under discussion. These terms of orientation are for convenience of description and do not require that the apparatus be constructed or operated in a particular orientation.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

1. A method for assembling a packaged semiconductor device, the method comprising:
(a) applying a pressure-sensitive gel material to an active region of a pressure-sensing integrated circuit (IC) die;
(b) dispensing a molding compound onto all exposed surfaces of the pressure-sensitive gel material to encapsulate the pressure-sensitive gel material; and
(c) removing a portion of the molding compound to expose the pressure-sensitive gel material to an ambient environment outside of the packaged semiconductor device.

2. The method of claim 1, wherein:
the pressure-sensitive gel material is a film; and
step (a) comprises adhering the film to an active region of the pressure-sensing IC die such that the film extends from the pressure-sensing IC die to a side perimeter of the packaged semiconductor device.

3. The method of claim 2, wherein step (c) comprises performing singulation along the side perimeter of the packaged semiconductor device to separate the pressure-sensing IC die from another pressure-sensing IC die, wherein the singulation removes the portion of the molding compound on the side perimeter of the packaged semiconductor device.

4. The method of claim 3, wherein step (c) comprises performing grinding to remove the portion of the molding compound on an upper perimeter of the packaged semiconductor device.

5. The method of claim 2, wherein:
in step (c), removing the portion of the molding compound exposes an opening in the molding compound at a perimeter of the packaged semiconductor device; and
the pressure-sensitive gel material occupies the opening at the perimeter of the packaged semiconductor device.

6. The packaged semiconductor device assembled using the method of claim 1.

7. A packaged semiconductor device, comprising:
a pressure-sensing integrated circuit (IC) die;
a pressure-sensitive gel material disposed on an active region of the pressure-sensing IC die; and
molding compound encapsulating the pressure-sensitive gel material, wherein:
a first surface of the pressure-sensitive gel material is exposed to an ambient environment outside of the packaged semiconductor device;
a second surface of the pressure-sensitive gel material contacts the pressure-sensing IC die; and
every other surface of the pressure-sensitive gel material is in contact with the molding compound.

8. The packaged semiconductor device of claim 7, wherein:
the pressure-sensitive gel material is a film;
the film is adhered to the active region of the pressure-sensing IC die and extends from the pressure-sensing IC die to a side perimeter of the packaged semiconductor device; and
the first surface of the pressure-sensitive gel material is exposed to the ambient environment via an opening in the molding compound on the side perimeter of the packaged semiconductor device.

9. The packaged semiconductor device of claim 7, wherein:
the pressure-sensitive gel material extends from the pressure-sensing IC die to an upper perimeter of the packaged semiconductor device; and
an opening in the molding compound on the upper perimeter of the packaged semiconductor device exposes the first surface of the pressure-sensitive gel material to the ambient environment.

10. The packaged semiconductor device of claim 9, wherein the pressure-sensitive gel material has a substantially spherical segment shape.

11. The packaged semiconductor device of claim 7, wherein the packaged semiconductor device does not include a lid.

12. A packaged semiconductor device, comprising:
a pressure-sensing integrated circuit (IC) die;
a pressure-sensitive gel film mounted on an active region of the pressure-sensing IC die and extending from the pressure-sensing IC die to a side perimeter of the packaged semiconductor device; and
molding compound encapsulating the pressure-sensitive gel film, wherein an opening in the molding compound on the side perimeter of the packaged semiconductor device exposes the pressure-sensitive gel film to an ambient environment outside of the packaged semiconductor device.
